(19) United States
(12) Patent Application Publication
(10) Pub. No.: US 2019/0030903 A1
(43) Pub. Date: Jan. 31, 2019

(54) INK REFILL CONTAINER

(71) Applicant: Seiko Epson Corporation, Tokyo (JP)

(72) Inventors: Noriyuki Fukasawa, Shiojiri-shi (JP); Taku Ishizawa, Matsumoto-shi (JP); Tadahiro Mizutani, Shiojiri-shi (JP)

(73) Assignee: Seiko Epson Corporation, Tokyo (JP)

(21) Appl. No.: 16/045,228

(22) Filed: Jul. 25, 2018

(30) Foreign Application Priority Data
Jul. 31, 2017 (JP) 2017-147817

(51) Int. Cl. B41J 2/175; B65D 47/10; B65D 47/12; B65D 47/40

(52) U.S. Cl. CPC B41J 2/17509; B41J 2/1754; B65D 2251/20; B65D 47/123; B65D 47/40; B65D 47/103

(57) ABSTRACT

An ink refill container is configured to refill an ink tank that is in communication with an ink ejection head with ink. The ink refill container includes an ink container body configured to contain the ink, a spout including an ink outlet that allows ink to flow out of the ink container body, a cap attached to the spout, and an ink absorbent arranged on the cap to absorb ink existing between the spout and the cap in a state in which the cap is attached to the spout.

The present application is based on, and claims priority from JP Application Serial Number 2017-147817, filed on Jul. 31, 2017, the disclosure of which is hereby incorporated by reference herein in its entirety.

### BACKGROUND

The present disclosure relates to an ink refill container that contains refill ink.

As one example of an ink refill container, JP-A-2017-81087 discloses a liquid-containing bottle used to refill a liquid tank (ink tank) of a printer with liquid (ink). The liquid-containing bottle includes a bottle portion (ink container body) containing liquid, a nozzle portion (spout) coupled to the bottle portion, and a cap attached to the nozzle portion.

The nozzle portion includes an opening that allows liquid to flow out. The inside of the cap includes a projection that is inserted into the opening to seal the opening. When the cap is not properly attached, liquid may leak out of the cap and cause contamination.

### SUMMARY

It is an object of the present disclosure to provide an ink refill container that reduces contamination outside the ink refill container.

In one aspect of the present disclosure, an ink refill container is configured to refill an ink tank that is in communication with an ink ejection head with ink. The ink refill container includes an ink container body configured to contain the ink, a spout including an ink outlet that allows ink to flow out of the ink container body, a cap attached to the spout, and an ink absorbent arranged on the cap to absorb ink that exists between the spout and the cap in a state in which the cap is attached to the spout.

With this structure, the ink absorbent of the cap absorbs the ink existing between the spout and the cap. This reduces the ink that collects on the spout and limits leakage of the ink. Thus, contamination caused by ink is reduced outside the ink refill container.

The cap may include a contact portion that contacts at least one of an inner side, an outer side, and a distal end of a portion of the spout forming the ink outlet in a state in which the cap is attached to the spout. Further, the ink absorbent is arranged on at least part of the contact portion.

With this structure, the ink absorbent is arranged on the contact portion that contacts at least one of the inner side, outer side, and distal end of the portion of the spout 38 forming the ink outlet. This allows for absorption of ink near the ink outlet where ink has a tendency to collect. Accordingly, contamination caused by ink is reduced outside the ink refill container.

The contact portion may include a ring-shaped lip that projects toward the spout in a state in which the cap is attached to the spout. Further, the lip defines a recess, and the ink absorbent is arranged in the recess. With this structure, the ink absorbent is arranged in the recess surrounded by the ring-shaped lip. Thus, the ink absorbent can be easily arranged in the recess.

In a further aspect of the present disclosure, an ink refill container is configured to refill an ink tank that is in communication with an ink ejection head with ink. The ink refill container includes an ink container body configured to contain the ink, a spout including an ink outlet that allows ink to flow out of the ink container body, and a cap attached to the spout. The cap includes a fit portion fitted to the ink outlet.

With this structure, the cap includes the fit portion that is fitted to the ink outlet. Thus, the cap can be easily attached to the spout by fitting the fit portion to the ink outlet. Accordingly, the ink outlet can be easily sealed with the cap, and contamination caused by ink is reduced outside the ink refill container.

At least the fit portion of the cap may be formed from an elastic material.

With this structure, the fit portion is formed from an elastic material. Thus, the cap that includes the fit portion can be easily attached to the spout. Accordingly, the ink outlet can be easily sealed with the cap, and contamination caused by ink is reduced outside the ink refill container.

In another aspect of the present disclosure, an ink refill container is configured to refill an ink tank that is in communication with an ink ejection head with ink. The ink refill container includes an ink container body configured to contain the ink, a spout including an ink outlet that allows ink to flow out of the ink container body, and a cap attached to the spout. The cap covers the ink outlet, and the spout includes a seal that seals the ink outlet. With this structure, the ink outlet is covered by the cap and sealed by the seal. This reduces contamination caused by ink outside the ink refill container.

The seal may be a film, and the cap may include a sharp portion having a sharp end.

With this structure, the cap includes the sharp portion. Thus, the film, which seals the ink outlet, can be torn when pierced with the sharp portion. Accordingly, the ink tank can be easily refilled with ink by tearing the film with the cap.

The seal may be a film, and the seal may be applied in a peelable manner to the spout.

With this structure, the film is applied in a peelable manner to the spout. Thus, the film can be separated from the spout to fill an ink tank with ink.

The seal may include a slit that does not extend through the seal.

With this structure, the seal includes the slit. Thus, the seal can be easily torn even when, for example, the seal is thick.

The seal may be configured to be torn by an ink inlet needle of the ink tank.

With this structure, the seal is torn by the ink inlet needle. Thus, the ink tank can be easily refilled with ink.

### BRIEF DESCRIPTION OF THE DRAWINGS

The disclosure may be understood by reference to the following description together with the accompanying drawings:

FIG. 1 is a perspective view of a printer;

FIG. 2 is a perspective view showing a state in which the printer of FIG. 1 is being refilled with ink from a first embodiment of an ink refill container;

FIG. 3 is a front view showing the printer of FIG. 3 in a state in which part of the printer has been eliminated;

FIG. 4 is a cross-sectional view of the ink refill container illustrated in FIG. 2;

FIG. 5 is a cross-sectional view showing part of a first cap of the ink refill container illustrated in FIG. 4;

FIG. 6 is a cross-sectional view taken along line 6-6 in FIG. 5;

FIG. 7 is a cross-sectional view showing part of a second embodiment of the ink refill container;

FIG. 8 is a cross-sectional view showing part of a third embodiment of the ink refill container;

FIG. 9 is a cross-sectional view showing part of the ink refill container illustrated in FIG. 8 when tearing a film with a sharp portion;

FIG. 10 is a cross-sectional view showing part of a first modified example of the ink refill container;

FIG. 11 is a cross-sectional view showing part of a second modified example of the ink refill container;

FIG. 12 is a cross-sectional view showing part of a first cap of a third modified example of the ink refill container;

FIG. 13 is a plan view showing a film of a fourth modified example of the ink refill container;

FIG. 14 is a cross-sectional view showing part of a fifth modified example of the ink refill container;

FIG. 15 is a cross-sectional view showing part of a sixth modified example of the ink refill container;

FIG. 16 is a cross-sectional view showing part of a seventh modified example of the ink refill container;

FIG. 17 is a cross-sectional view showing part of an eighth modified example of the ink refill container;

FIG. 18 is a cross-sectional view showing part of a ninth modified example of the ink refill container;

FIG. 19 is a cross-sectional view showing part of a tenth modified example of the ink refill container; and

FIG. 20 is a front view showing part of an eleventh modified example of the ink refill container.

### DESCRIPTION OF EXEMPLARY EMBODIMENTS

### First Embodiment

A first embodiment of an ink refill container configured to refill an ink tank of a printer with ink will now be described with reference to the drawings.

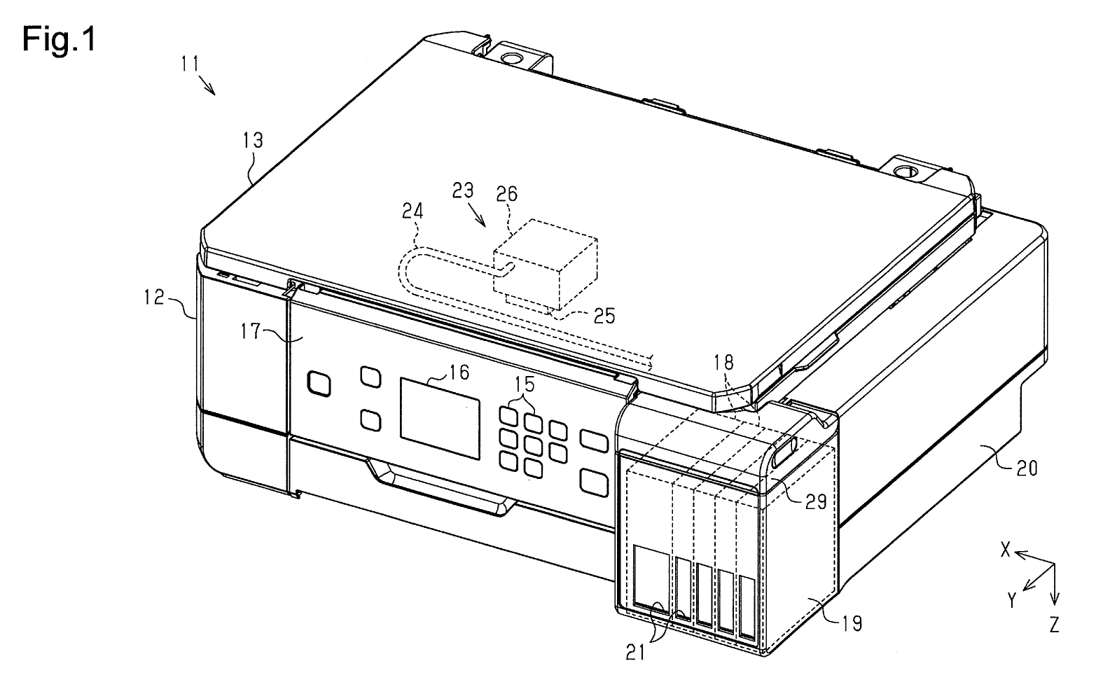

As shown in FIG. 1, an all-in-one machine 11, which is generally box-shaped as a whole, includes a printer 12 and an image reading device 13 arranged on the printer 12 so as to cover the printer 12.

As viewed in FIG. 1, in a state in which the all-in-one machine 11 is placed on a horizontal plane, the vertical direction is represented by the Z-axis and the directions that are orthogonal to the vertical direction and parallel to the horizontal plane are represented by the X-axis and the Y-axis. The X-axis, the Y-axis, and the Z-axis are orthogonal to one another. In the description hereafter, the direction in which the X-axis extends will also be referred to as the widthwise direction, and the direction in which the Y-axis extends will also be referred to as the front-rear direction. The widthwise direction, the front-rear direction, and the vertical direction intersect (for example, are orthogonal to) one another. The front with respect to the front-rear direction may be referred to as the front side or the forward side. The rear with respect to the front-rear direction may be referred to as the rear side of the backward side. One side in the widthwise direction as viewed from the front side may be referred to as the right side, and the other side in the widthwise direction as viewed from the front side may be referred to as the left side.

The front side of the printer 12 includes an operation panel 17. The operation panel 17 includes operation portions 15, such as buttons used to operate the all-in-one machine 11, and a display 16 that shows information of the printer 12 and the all-in-one machine 11. The right side of the operation panel 17 includes a tank compartment 19 that accommodates at least one ink tank 18 (five ink tanks 18 in the present embodiment). The ink tanks 18 are arranged in a housing 20 of the printer 12. The housing 20 includes at least one window 21 (five windows 21 in the present embodiment). Each window 21 corresponds to one of the ink tanks 18.

Printing unit 23 and feeders 24 are arranged in the housing 20. The printing unit 23 applies ink to a medium (not shown) to perform printing. The feeders 24 each include a tube or the like to supply the printing unit 23 with ink from the corresponding ink tank 18. The printing unit 23 includes an ink ejection head 25 that ejects ink from nozzles (not shown) and a carriage 26 that is configured to hold the ink ejection head 25 and move back and forth in the widthwise direction (scanning direction). The ink tanks 18 are in communication with the ink ejection heads 25 via the feeders 24 to supply the ink ejection heads 25 with ink.

The printing units 23 eject ink from the moving ink ejection head 25 toward the medium to print characters or images on the medium. FIG. 1 shows only one feeder 24 for the sake of brevity. However, there is more than one feeder 24, with each feeder 24 corresponding to one of the ink tanks 18.

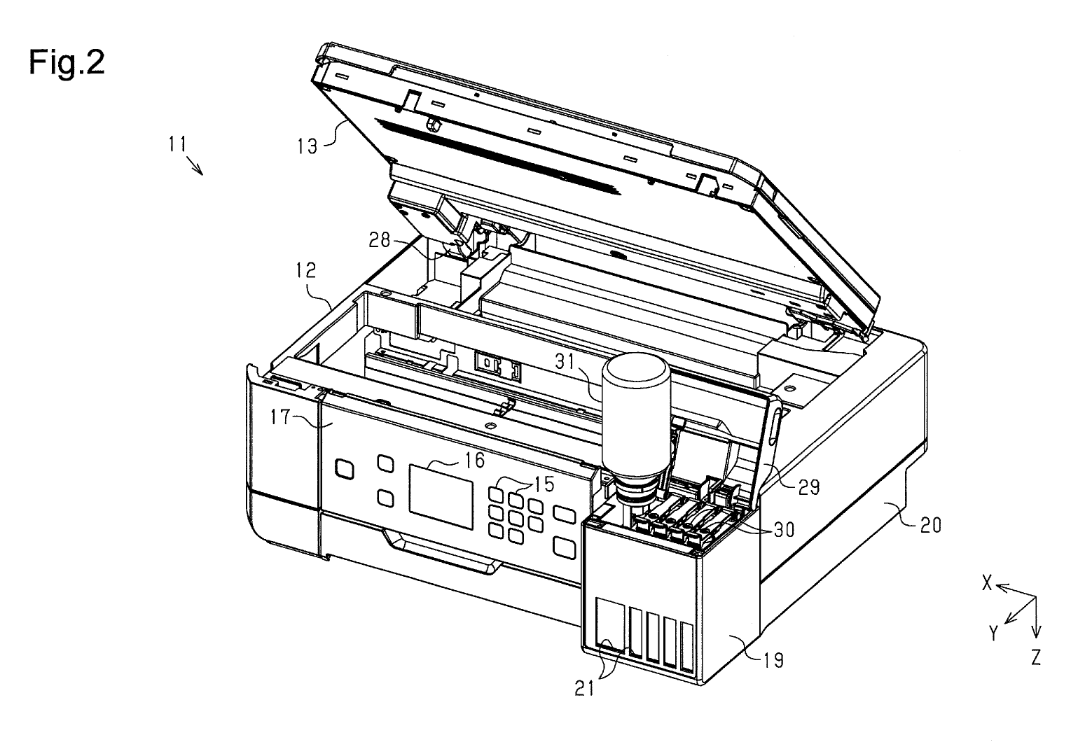

As shown in FIG. 2, the image reading device 13 is coupled to the printer 12 by a rotation mechanism 28 such as a hinge arranged at the rear side. The image reading device 13 is configured to open and close the printer 12 and pivot between a closed position shown in FIG. 1 and an open position shown in FIG. 2. When the image reading device 13 is located at the open position, a cover 29 of the tank compartment 19 and plugs 30 attached to the ink tanks 18 can be opened and closed. As shown in FIG. 2, the image reading device 13, the cover 29, and a plug 30 are moved to the open position when refilling an ink tank 18 with ink. Then, an ink refill container 31 containing refill ink is coupled to the ink tank 18. In this manner, the ink refill container 31 is configured to refill the ink tank 18 with ink.

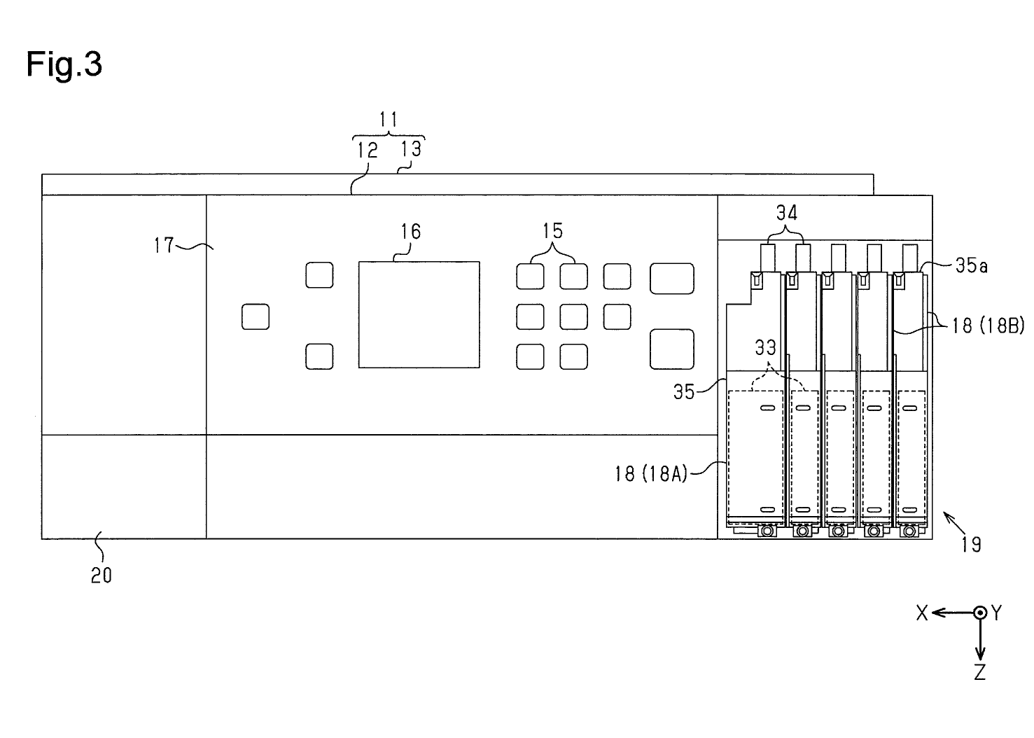

As shown in FIG. 3, each ink tank 18 includes a reservoir 33 that stores ink. Each ink tank 18 stores a different type of ink in the reservoir 33. The different types of ink may be of different colors (e.g., cyan, magenta, yellow, and black) or include different colorants such as pigments and dyes. In the present embodiment, a first ink tank 18A, which has a large volume and contains black ink, is located near the operation panel 17 and four second ink tanks 18B, which have a smaller volume and contain inks of colors other than black, are arranged next to the first ink tank 18A.

Each ink tank 18 includes an ink inlet needle 34 that allows ink to be drawn into the reservoir 33. The ink tank 18 is formed by a tank case 35 including an upper surface 35a. The substantially cylindrical ink inlet needle 34 projects upward from the upper surface 35a. The hollow interior of the ink inlet needle 34 is in communication with the reservoir 33 and functions as an inlet passage that allows ink to be drawn into the reservoir 33. The plug 30 is attached to the distal end of the ink inlet needle 34 to seal the inlet passage.

The ink refill container 31 will now be described.

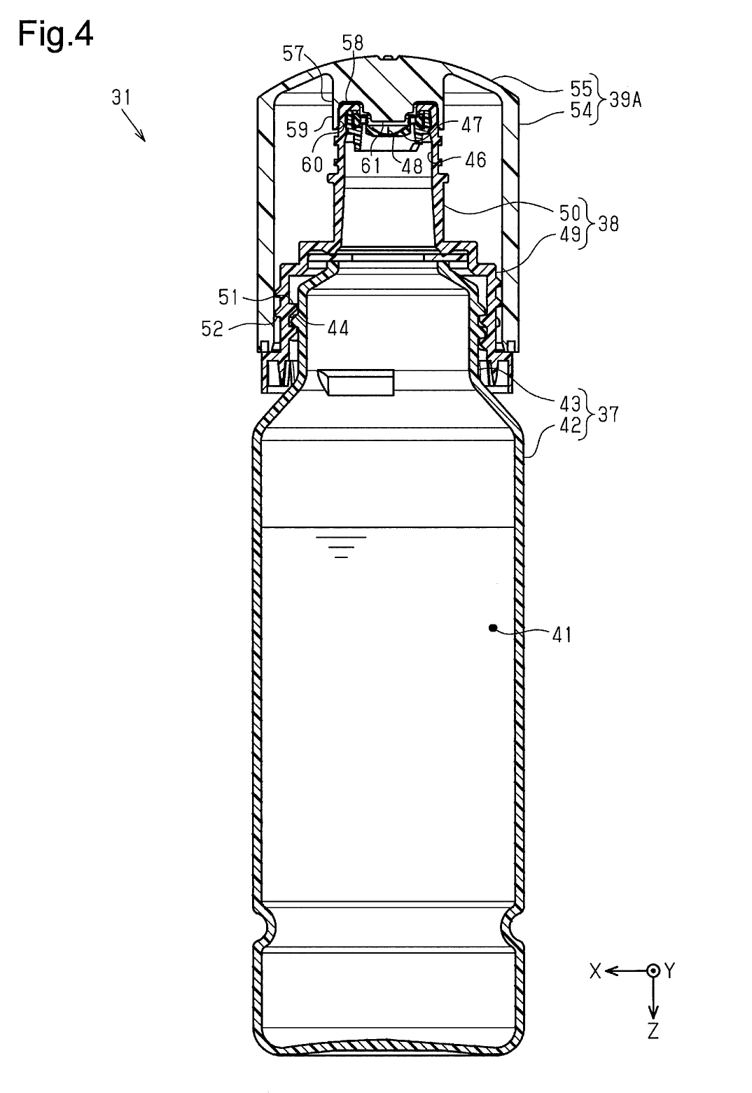

As shown in FIG. 4, the ink refill container 31 includes an ink container body 37 allowing for the storage of an ink, a spout 38 arranged on the ink container body 37, and a first cap 39A attached in a removable manner to the spout 38. The spout 38 is separate from the ink refill container 31 and attached in a removable manner to the ink refill container 31. The ink refill container 31 may be stored in a storage position that is shown in FIG. 4. In the storage position, the spout 38 and the first cap 39A are located at the vertically upper end (distal end) of the ink container body 37. The structure of the ink refill container 31 will now be described using the storage position as a frame of reference.

The ink container body 37 includes a vessel 42 and a neck 43 that are both cylindrical. The vessel 42 includes a circumferential wall and a bottom wall closing one end of the cylindrical wall to define a vessel chamber 41 that contains ink. The neck 43 has a smaller diameter than the vessel 42. The neck 43 extends upward from the distal end of the vessel 42. The outer circumferential surface of the neck 43 includes a first male thread 44.

The spout 38 includes an ink outlet 46 that allows ink to flow out of the vessel chamber 41. The spout 38 includes a valve 47 formed by, for example, an elastic member such as a silicone film. The valve 47 includes a plurality of (e.g., three) slits 48 that connect at the center of the valve 47. The slits 48 are arranged at equal angular intervals (e.g., 120-degree intervals). The slits 48 may extend through the valve 47 or may be cut into the valve 47 toward the ink outlet 46 without extending through the valve 47. The valve 47 includes an inner surface faced toward the interior of the spout 38 and an outer surface faced toward the first cap 39A. The slits 48 are formed in the outer surface of the valve 47 with a depth reaching the inner surface or a depth not reaching the inner surface.

Even when the slits 48 extend through the valve 47, the slits 48 are closed and the ink outlet 46 is sealed as long as the valve 47 is not pushed from the outside. Thus, the valve 47 functions as one example of a seal that seals the ink outlet 46.

As shown in FIG. 4, when attached to the ink container body 37, the spout 38 includes a large diameter portion 49 and a small diameter portion 50. The large diameter portion 49 is located outward from the neck 43. The small diameter portion 50 is the distal portion of the spout 38 that is separated from the ink container body 37 and includes the ink outlet 46. The inner circumferential surface of the large diameter portion 49 includes a female thread 51 that can be joined with the first male thread 44. The spout 38 is attached to the ink container body 37 by joining the female thread 51 and the first male thread 44. The outer circumferential surface of the large diameter portion 49 includes a second male thread 52.

The first cap 39A includes a cylindrical side wall 54 and a dome-shaped top wall 55 closing the distal end of the side wall 54. The inner circumferential surface of the side wall 54 includes a second female thread (not shown). The first cap 39A is attached to the spout 38 by joining the second female thread of the first cap 39A with the second male thread 52. More specifically, the first cap 39A is rotated in an attachment direction to be attached to or removed from the spout 38. The attachment direction is the vertical direction with respect to the storage position, the direction in which the spout 38 extends, and the direction in which the ink outlet 46 opens. When the first cap 39A is attached to the spout 38, the first cap 39A covers and hides the ink outlet 46 of the spout 38.

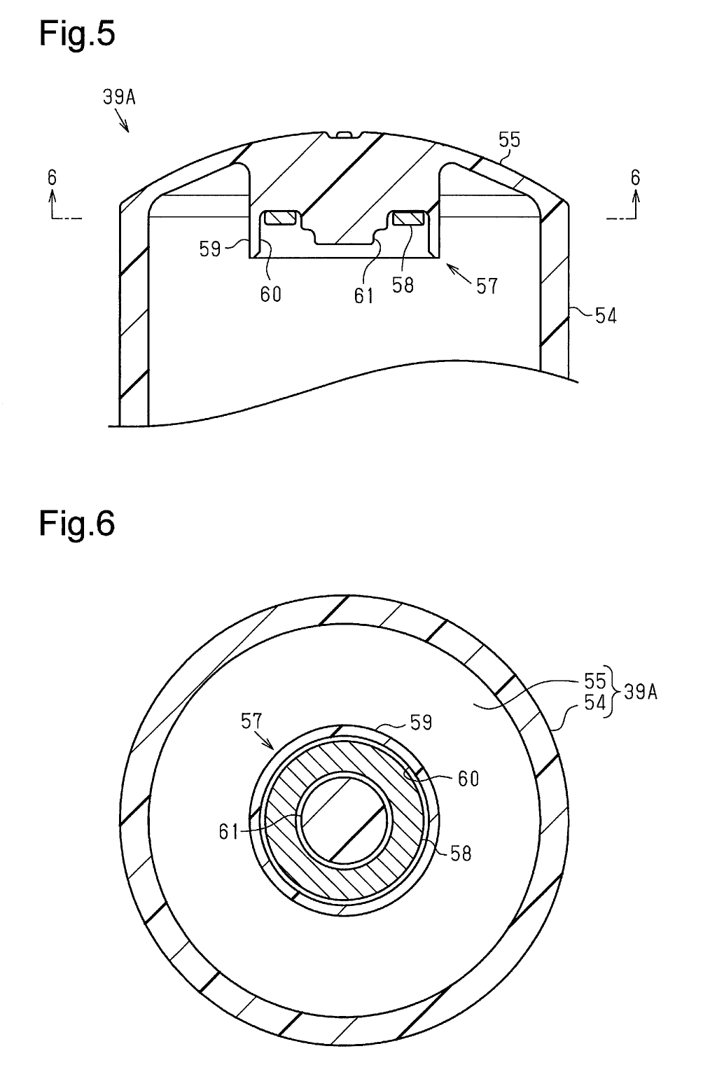

As shown in FIGS. 4 and 5, the first cap 39A includes a contact portion 57 and an ink absorbent 58. In a state in which the first cap 39A is attached to the spout 38, the contact portion 57 contacts the small diameter portion 50 of the spout 38 that includes the ink outlet 46, and the ink absorbent 58 absorbs ink. The contact portion 57 contacts the distal end region (open end region) of the spout 38 that forms the ink outlet 46. In a state in which the first cap 39A is attached to the spout 38, the contact portion 57 projects from the top wall 55 toward the spout 38. In a state in which the first cap 39A is attached to the spout 38, the contact portion 57 includes a ring-shaped lip 59 that projects downward and toward the spout 38 and a projection 61 that projects toward the spout 38 from a recess 60 defined by a region surrounded by the lip 59.

In a state in which the first cap 39A is attached to the spout 38, the inner circumferential surface of the lip 59 contacts the outer circumferential surface of the spout 38. The projection 61 is located at the center of the region surrounded by the substantially ring-shaped lip 59. In a state in which the first cap 39A is attached to the spout 38, the projection 61 is located in the spout 38 spaced apart from the spout 38 by a gap.

As shown in FIGS. 5 and 6, the annular recess 60, which opens downward, is located between the lip 59 and the projection 61. The ink absorbent 58 is, for example, an elastically deformable porous body such as a sponge. The ink absorbent 58 is located in the recess 60, which is surrounded by the lip 59, and arranged on at least part of the contact portion 57. When the contact portion 57 contacts the outer side of the portion of the spout 38 that forms the ink outlet 46, in a state sandwiched between the first cap 39A and the spout 38, the ink absorbent 58 contacts the distal end (open end) of the spout 38, more specifically, the distal end surface (open end surface) of the spout 38. In a state in which the first cap 39A is attached to the spout 38, the ink absorbent 58 may be located outward from the ink outlet 46 and the valve 47.

The operation of the ink refill container 31 will now be described.

With reference to FIG. 2, when refilling an ink tank 18 with ink from the ink refill container 31, the first cap 39A is removed from the ink refill container 31. Then, the ink refill container 31 is held in a refilling position so that the spout 38 is located at the lower end of the ink container body 37 in the vertical direction (refer to FIG. 2). The ink refill container 31 includes the valve 47. Thus, the flow of ink out of the ink outlet 46 is restricted even when changing the position of the ink refill container 31.

When the ink inlet needle 34 is inserted into the ink outlet 46, the ink inlet needle 34 presses the valve 47 to open the valve 47 by widening the slits 48 from the outer side of the ink outlet 46 toward the inner side of the ink outlet 46. Even when the slits 48 do not extend through the valve 47, the valve 47 presses and tears open the ink inlet needle 34. In this manner, the valve 47 can be teared by the ink inlet needle 34 of the ink tank 18. When the ink inlet needle 34 and the ink outlet 46 are in communication, the ink tank 18 is refilled with the ink of the ink refill container 31.

Removal of the ink refill container 31 from the ink inlet needle 34 closes the slits 48. This, in turn, closes the valve 47. More specifically, the valve 47 functions as a normally closed valve that opens when the slits 48 are pressed from the outer side of the ink outlet 46 toward the inner side of the ink outlet 46 and closes as long as the ink outlet 46 is separated from the ink inlet needle 34. After refilling the ink tank 18 with ink, ink may collect on the ink outlet 46 and around the ink outlet 46.

As shown in FIG. 4, when the first cap 39A is attached to the spout 38, the ink absorbent 58 is in contact with the distal end of the small diameter portion 50 that forms the ink outlet 46. Thus, the ink on the spout 38 collects at the inner side of the contact portion 57 where the ink is absorbed by the ink absorbent 58. More specifically, the ink absorbent 58 absorbs the ink existing between the first cap 39A and the spout 38 to which the first cap 39A is attached.

The first embodiment has the advantages described below.

(1-1) The ink absorbent 58 of the first cap 39A absorbs the ink existing between the spout 38 and the first cap 39A. This reduces the ink that collects on the spout 38 and limits the leakage of ink. Thus, contamination caused by ink is reduced outside the ink refill container 31.

(1-2) The ink absorbent 58 is included in the contact portion 57 that contacts the outer side of the portion of the spout 38 forming the ink outlet 46. This allows the ink absorbent 58 to absorb ink from around the ink outlet 46 where ink easily collects and reduces contamination caused by link outside the ink refill container 31.

(1-3) The ink absorbent 58 is located in the recess 60, which is surrounded by the ring-shaped lip 59. This facilitates the arrangement of the ink absorbent 58 in the first cap 39A.

(1-4) The valve 47, which functions as a seal, includes the slits 48. Thus, the valve 47 can easily be opened or teared even when, for example, the seal is thick.

(1-5) The seal can be teared with the ink inlet needle 34, even when the slits 48 do not extend through the valve 47. This allows for easy refilling of the ink tanks 18.

(1-6) The ink absorbent 58 is located in the recess 60 that is surrounded by the ring-shaped lip 59. This limits the leakage of the ink absorbed by the ink absorbent 58 out of the ring-shaped lip 59.

(1-7) In the example of patent document 1, when the projection in the cap is inserted into the opening of the nozzle portion to seal the opening, liquid may collect on the projection and the nozzle portion. The collection of liquid in such a manner may cause contamination. Further, a user may determine that a liquid container bottle has been used even though it has not yet been used. Moreover, solidification of the collected liquid may adversely affect the seal of the opening and cause leakage of the liquid. In this respect, the first cap 39A includes the contact portion 57 and the ink absorbent 58. This reduces the ink that collects on the spout 38. Accordingly, contamination caused by ink can be reduced. Further, an unused state of the ink refill container 31 is easy to recognize. Moreover, the leakage of ink is limited.

### Second Embodiment

A second embodiment of the ink refill container will now be described with reference to the drawings. The second embodiment differs from the first embodiment in the structure of the cap. Otherwise, the structure of the second embodiment is the same as the first embodiment. Same reference numerals are given to those components that are the same as the corresponding components of the first embodiment. Such components will not be described in detail.

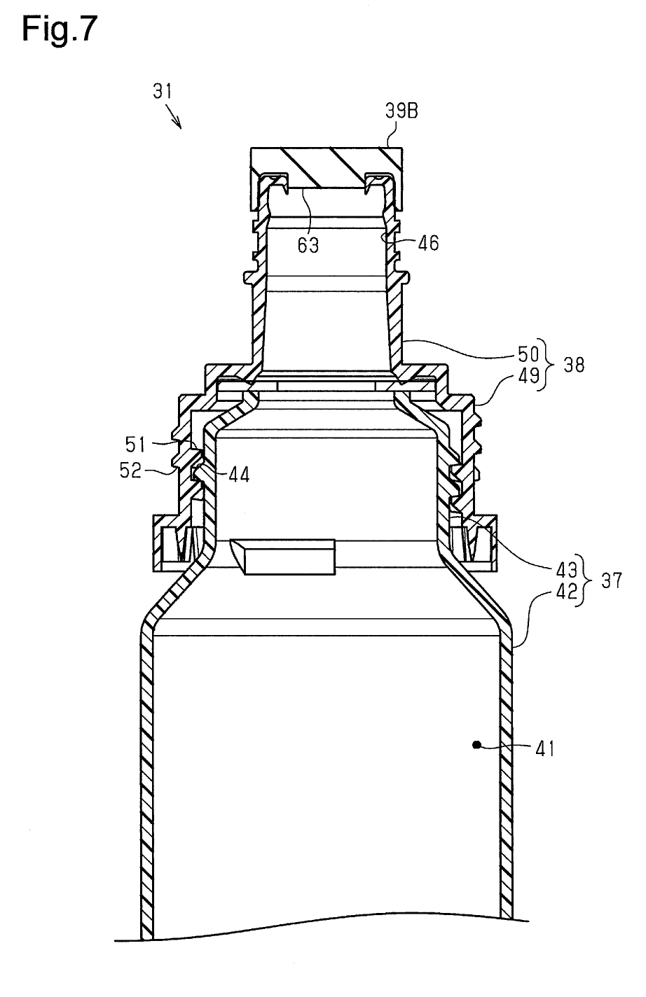

As shown in FIG. 7, a second cap 39B includes a fit portion 63 that is formed to be fitted to the ink outlet 46 of the spout 38. In a state in which the second cap 39B is attached to the spout 38, the fit portion 63 is in contact with the ink outlet 46, that is, the inner side of the portion of the spout 38 forming the ink outlet 46. The fit portion 63 functions as one example of a contact portion. The second cap 39B may also be configured to contact at least one of the distal end and outer side of the portion of the spout 38 forming the ink outlet 46.

The second cap 39B may be entirely formed from an elastic material such as rubber, for example, a silicone elastomer. Alternatively, just the part of the second cap 39B that functions as the fit portion 63 may be formed from an elastic material. In this manner, at least the fit portion 63 of the second cap 39B is formed from an elastic material.

The operation of the ink refill container 31 will now be described.

When removing the second cap 39B from the spout 38, the second cap 39B is pulled off the spout 38. When attaching the second cap 39B to the spout 38, the fit portion 63 is positioned on the ink outlet 46, that is, in contact with the inner side of the distal end of the spout 38. In this state, the second cap 39B is pressed against the spout 38 to move the second cap 39B in the attachment direction and fit the fit portion 63 onto the ink outlet 46.

In addition to the advantages of the first embodiment, the second embodiment has the advantages described below.

(2-1) The second cap 39B includes the fit portion 63 that is fitted to the ink outlet 46. The fit portion 63 is fitted to the ink outlet 46 so that the second cap 39B is easily attached to the spout 38. Accordingly, the second cap 39B easily seals the ink outlet 46 and reduces contamination caused by ink outside the ink refill container 31.

(2-2) The fit portion 63 is formed from an elastic material. Thus, the second cap 39B that includes the fit portion 63 is easily attached to the spout 38. Accordingly, the second cap 39B easily seals the ink outlet 46 and reduces contamination caused by ink outside the ink refill container 31.

(2-3) In the example of patent document 1, when a threaded cap and a threaded nozzle are joined with each other, the cap may not be properly attached to the nozzle. More specifically, when the cap is not completely joined with the nozzle or when the cap is joined with the nozzle in a tilted state, the cap may not be properly attached to the nozzle. In such a case, ink may leak out from between the cap and nozzle and cause contamination. In this regard, the second cap 39B includes the fit portion 63 that is elastically fitted to the ink outlet 46. Thus, the second cap 39B easily closes the ink outlet 46 and reduces contamination caused by ink outside the ink refill container 31.

### Third Embodiment

A third embodiment of the ink refill container will now be described with reference to the drawings. The third embodiment differs from the first embodiment in the structure of the cap and the spout. Otherwise, the structure of the third embodiment is the same as the first embodiment. Same reference numerals are given to those components that are the same as the corresponding components of the first embodiment. Such components will not be described in detail.

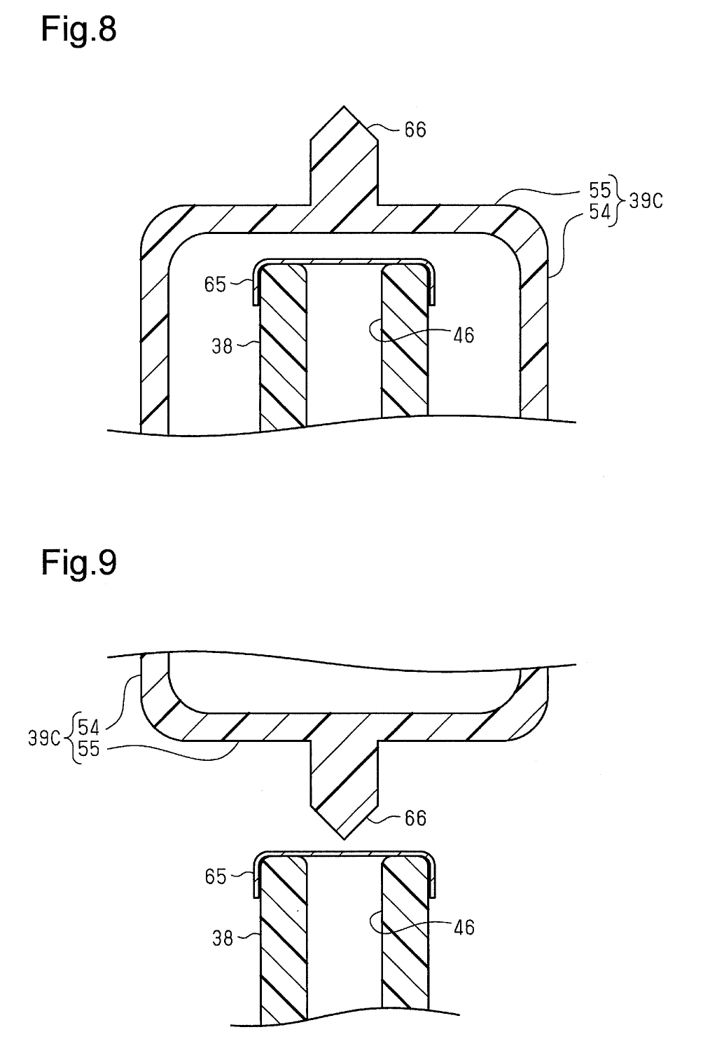

As shown in FIG. 8, a third cap 39C covers the ink outlet 46. The spout 38 includes a film 65 functioning as one example of a seal that seals the ink outlet 46. The film 65 is applied to the distal portion of the spout 38 where the ink outlet 46 is formed. The third cap 39C covers the distal portion of the spout 38 where the film 65 is applied at the outer side of the film 65. The third cap 39C includes the cylindrical side wall 54, the top wall 55 that closes the distal end of the side wall 54, and a sharp portion 66 that projects from the top wall 55. In a state in which the third cap 39C is attached to the spout 38, the sharp portion 66 projects from the top wall 55 toward the side opposite to the spout 38 (upward). The sharp portion 66 is formed to have a sharp distal end having the form of, for example, a circular cone or a polygonal cone. The sharp portion 66, which has a smaller diameter than the ink outlet 46, can be used to tear the film 65.

The operation of the ink refill container 31 will now be described.

As shown in FIG. 9, when refilling an ink tank 18 with ink from the ink refill container 31, the third cap 39C is removed from the spout 38. Then, the sharp portion 66 is pierced through the film 65, which covers the ink outlet 46. This tears the film 65 so that the ink outlet 46 is in communication with the outside. In this state, the ink refill container 31 can refill the ink tank 18 with ink.

In addition to the advantages of the first and second embodiments, the third embodiment has the advantages described below.

(3-1) The ink outlet 46 is covered by the third cap 39C and sealed by the film 65. This limits the leakage of ink and reduces contamination caused by ink outside the ink refill container 31.

(3-2) The third cap 39C includes the sharp portion 66. Thus, the sharp portion 66 can be used to pierce and tear the film 65, which seals the ink outlet 46. The use of the third cap 39C to tear the film 65 allows for easy refilling of the ink tanks 18 with ink.

It should be apparent to those skilled in the art that the present invention may be embodied in many other specific forms without departing from the spirit or scope of the invention. Also, the components disclosed in the embodiments and the modified examples may be assembled in any combination, and the components disclosed in the modified examples may be assembled in any combination.

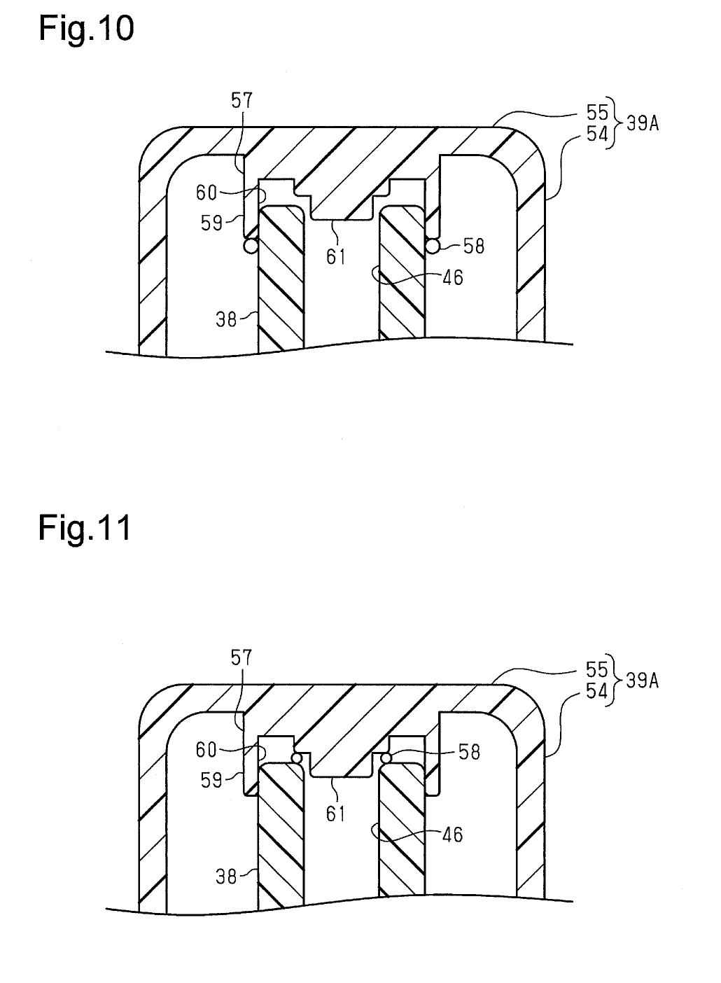

As illustrated in a first modified example of FIG. 10, the ink absorbent 58 may be arranged on the distal end of the lip 59. The ink absorbent 58 may be arranged where the spout 38 contacts the contact portion 57, that is, in contact with the outer surface of the spout 38.

As illustrated in a second modified example of FIG. 11, the ink absorbent 58 may be located between the distal end (distal end surface) of the spout 38 and the projection 61.

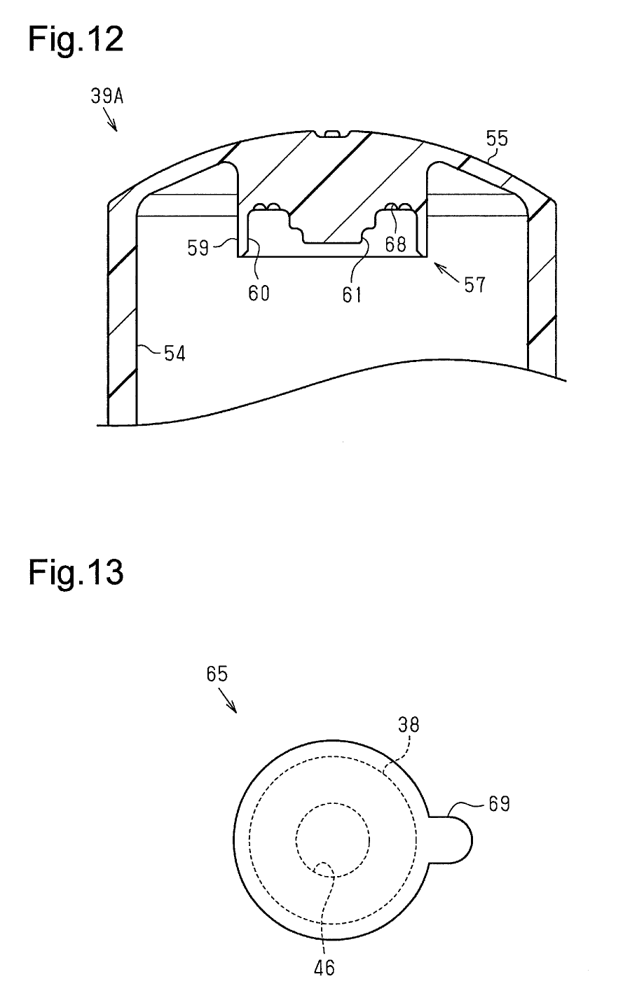

As illustrated in a third modified example of FIG. 12, the contact portion 57 of the first cap 39A may include grooves 68 serving as an example of an ink absorbent. More specifically, the ink absorbent need only be configured to hold ink and capillary action may be used to draw ink from between the first cap 39A and the spout 38 into the grooves 68. The ink absorbent may be fine ridges and valleys that can hold ink.

As illustrated in a fourth modified example of FIG. 13, the film 65 may include a tab 69. The film 65 may be peelable from the spout 38. Since the film 65 is peelable from the spout 38, separation of the film 65 from the spout 38 allows the ink tank 18 to be easily refilled with ink.

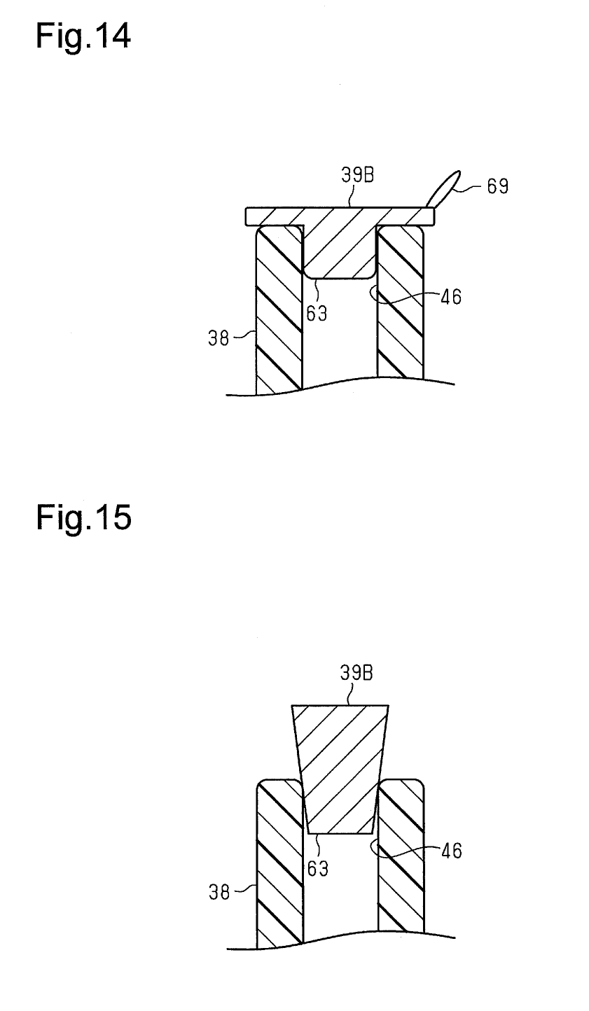

As illustrated in a fifth modified example of FIG. 14, the second cap 39B may include the tab 69.

As illustrated in a sixth modified example of FIG. 15, the second cap 39B may have, for example, the form of a truncated cone like a cork plug. In this case, the second cap 39B is fitted into the ink outlet 46 to seal the ink outlet 46.

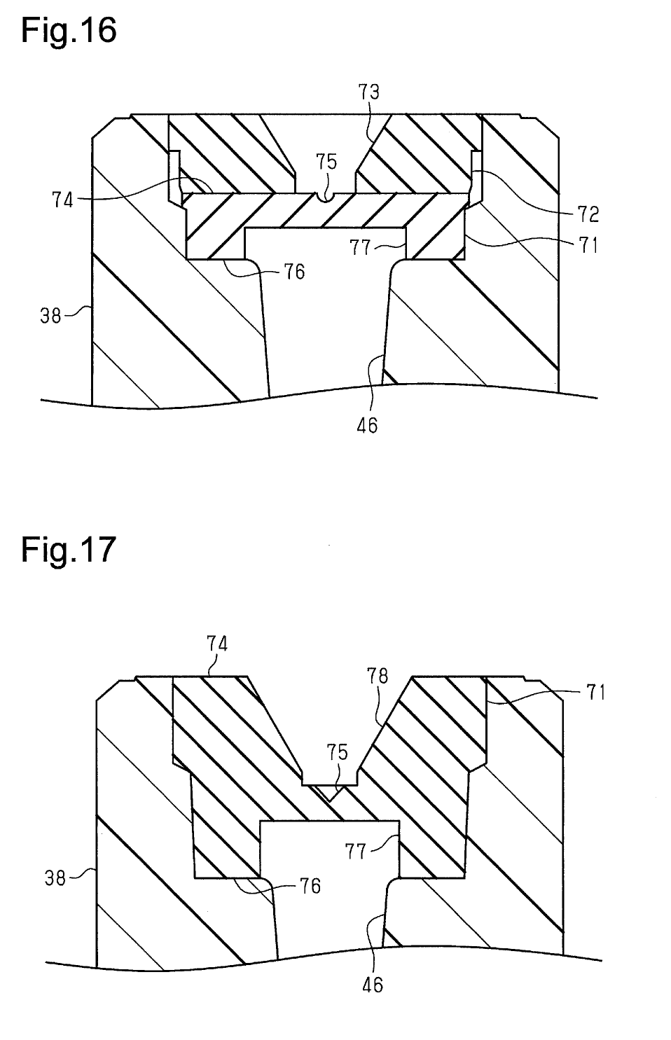

As illustrated in a seventh modified example of FIG. 16, the ink refill container 31 may include a seal 71 that seals the ink outlet 46 and an elastic body 72 that is located toward the distal side of the ink refill container 31 from the seal 71. A through hole 73 extends through the elastic body 72. Thus, the elastic body 72 is ring-shaped. The through hole 73 is sized so that when the ink inlet needle 34 is inserted through the through hole 73, the wall surface of the through hole 73 contacts the ink inlet needle 34 and seals the ink inlet needle 34. The through hole 73 may have a diameter that is small near the seal 71 but increases toward the distal end. The seal 71 includes a first surface 74 that contacts the elastic body 72 and a second surface 76 that is located at the opposite side of the first surface 74. The central portion of the first surface 74 includes a concave first recess 75, and the central portion of the second surface 76 includes a cylindrical second recess 77. In this manner, the seal 71 is thin at the central portion including the first recess 75 and the second recess 77 and thick at the radially outer portion surrounding the central portion. Thus, in a state in which the distal end of the ink inlet needle 34 is positioned on the first recess 75, the ink inlet needle 34 is inserted into the ink refill container 31. This easily tears the thin portion of the seal 71 with the ink inlet needle 34.

As illustrated in an eighth modified example of FIG. 17, the first surface 74 of the seal 71 may include the first recess 75 and a third recess 78, and the second surface 76 may include a second recess 77. More specifically, in the seventh modified example, the elastic body 72 and the seal 71 are formed integrally. The third recess 78 has the form of a truncated cone so that the diameter decreases as the first surface 74 becomes farther. The second recess 77 is cylindrical. The first recess 75 is located in the bottom wall of the third recess 78.

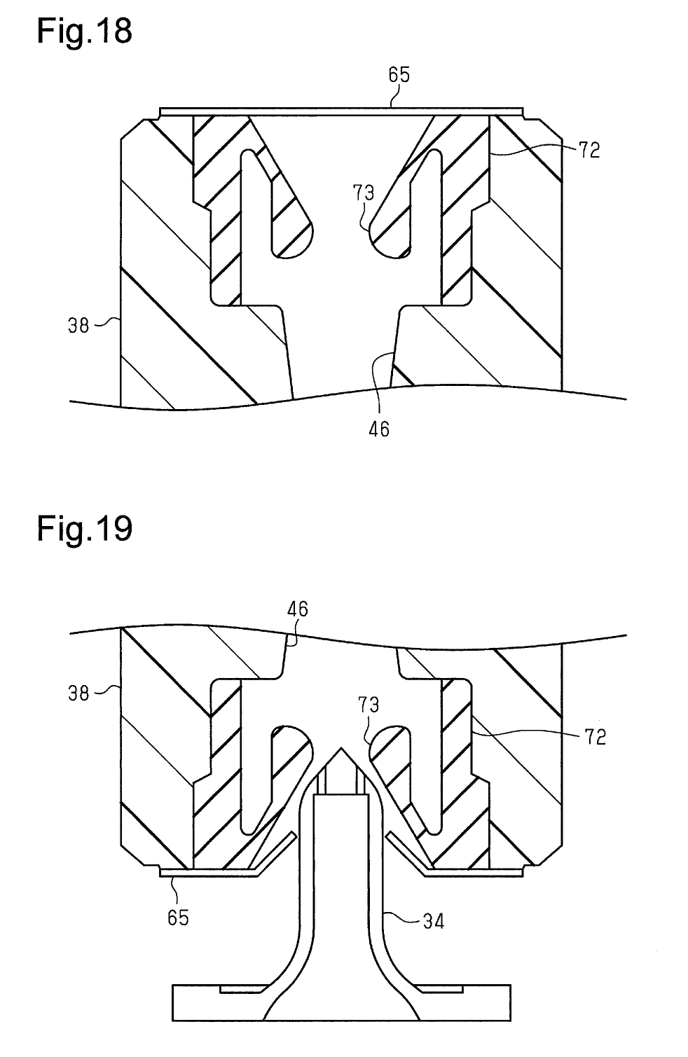

As illustrated in a ninth modified example of FIG. 18, the film 65 seals the ink outlet 46 to cover the elastic body 72, which includes the through hole 73.

As illustrated in a tenth modified example of FIG. 19, to facilitate tearing of the film 65, the ink inlet needle 34 may include a distal end surface sloped relative to a plane that is orthogonal to the longitudinal axis of the ink inlet needle 34. In other words, the ink inlet needle 34 may include a sharp distal end.

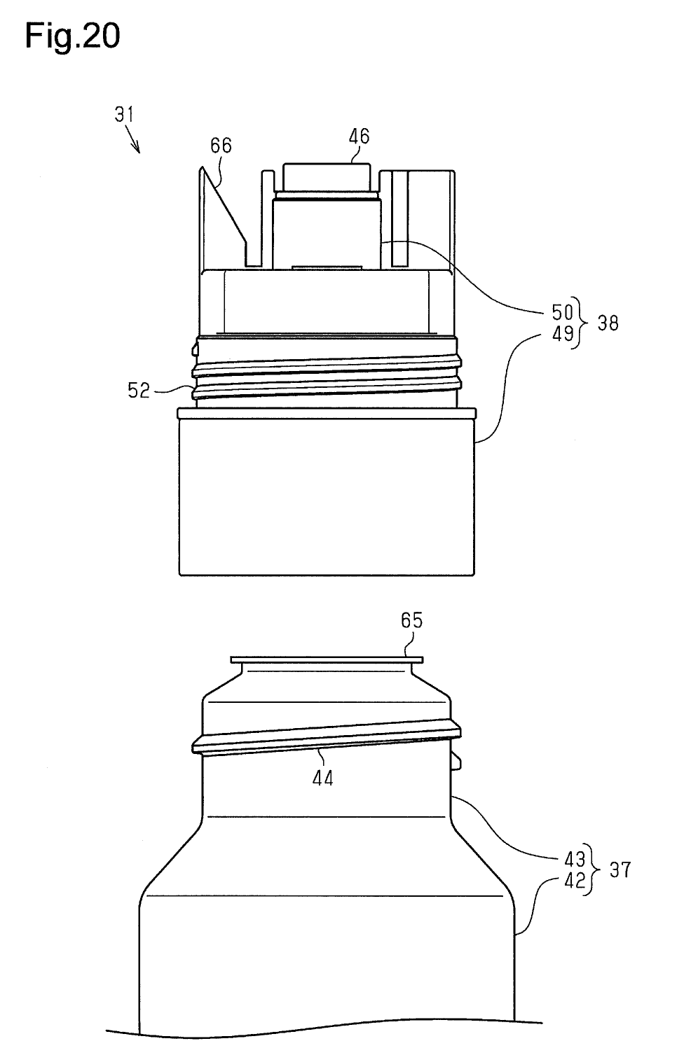

As illustrated in an eleventh modified example of FIG. 20, the opening of the ink container body 37 may be sealed with the film 65. The spout 38 may include the sharp portion 66 that has a sharpened end. More specifically, the film 65 may be teared with the sharp portion 66 of the spout 38. The printer 12 or each ink tank 18 may include an engagement portion (not shown) that is engageable with the sharp portion 66 of the spout 38. When refilling an ink tank 18 with ink, the engagement portion is engageable with the sharp portion 66 when the ink refill container 31 and the ink tank 18 are correctly combined and not engageable with the sharp portion 66 when the ink refill container 31 and the ink tank 18 are not correctly combined.

The ink container body 37 may have any structure as long as the vessel chamber 41 can contain ink. For example, the ink container body 37 may be a flexible bag, a bottle, a tank, a can, or the like.

The ink container body 37 and the spout 38 may be formed integrally.

The first cap 39A and the third cap 39C may be attached to the ink container body 37.

The ink refill container 31 may be configured not to include the first cap 39A and the third cap 39C.

The ink absorbent 58 of the ink refill container 31 may be of a color that is the same as the color of the contained ink. The ink absorbent 58 may be formed from fibers or polymers of cellulose or the like.

The ink absorbent 58 of the ink refill container 31 may be located at a position separated from the contact portion 57.

The ink absorbent 58 may include a guide passage such as a groove to guide the flow of ink. The guide passage may be arranged so that the portion where the spout 38 and the first cap 39A are in contact is in communication with the ink absorbent 58.

When the first cap 39A is attached to the spout 38, the ink absorbent 58 may be separated from the spout 38.

The contact portion 57 may be formed so as to be less the ring-shaped lip 59. The lip 59 does not have to be ring-shaped.

The lip 59 does not have to be ring-shaped and may have any shape. For example, the lip 59 may be rectangular or elliptical.

The projection 61 may be sized to come into contact with the ink outlet 46 when the first cap 39A is attached to the spout 38. More specifically, in a state in which the first cap 39A is attached to the spout 38, the contact portion 57 may contact the ink outlet 46 (inner side of distal portion of spout 38).

The contact portion 57 may be configured to contact at least one of the inner side, and the outer side, and a distal end of the portion of the spout 38 forming the ink outlet 46. For example, the contact portion 57 may be configured to contact only the distal end of the ink outlet 46.

The ink refill container 31 may be less the valve 47.

The ink refill container 31 may be less the contact portion 57.

Any ink may be used as long as the ink can be applied to a medium to print characters or images on the medium. For example, ink includes particles of a functional material formed by a solid such as pigments or metal particles that are dissolved, dispersed, or mixed in a solvent. Further, ink includes various compositions such as water-based ink, oil-based ink, gel ink, and hot melt ink.

The present examples and embodiments are to be considered as illustrative and not restrictive, and the invention is not to be limited to the details given herein.

1. An ink refill container configured to refill an ink tank that is in communication with an ink ejection head with ink, the ink refill container comprising:
an ink container body configured to contain the ink;
a spout including an ink outlet that allows ink to flow out of the ink container body;
a cap attached to the spout; and
an ink absorbent arranged on the cap to absorb ink that exists between the spout and the cap in a state in which the cap is attached to the spout.

2. The ink refill container according to claim 1, wherein:
the cap includes a contact portion that contacts at least one of an inner side, an outer side, and a distal end of a portion of the spout forming the ink outlet in a state in which the cap is attached to the spout; and
the ink absorbent is arranged on at least part of the contact portion.

3. The ink refill container according to claim 2, wherein
the contact portion includes a ring-shaped lip that projects toward the spout in a state in which the cap is attached to the spout,
the lip defines a recess, and
the ink absorbent is arranged in the recess.

4. An ink refill container configured to refill an ink tank that is in communication with an ink ejection head with ink, the ink refill container comprising:
an ink container body configured to contain the ink;
a spout including an ink outlet that allows ink to flow out of the ink container body; and
a cap attached to the spout, wherein the cap includes a fit portion fitted to the ink outlet.

5. The ink refill container according to claim 4, wherein at least the fit portion of the cap is formed from an elastic material.

6. An ink refill container configured to refill an ink tank that is in communication with an ink ejection head with ink, the ink refill container comprising:
an ink container body configured to contain the ink;
a spout including an ink outlet that allows ink to flow out of the ink container body; and
a cap attached to the spout, wherein the cap covers the ink outlet, and the spout includes a seal that seals the ink outlet.

7. The ink refill container according to claim 6, wherein
the seal is a film, and
the cap includes a sharp portion having a sharp end.

8. The ink refill container according to claim 6, wherein
the seal is a film, and
the seal is applied in a peelable manner to the spout.

9. The ink refill container according to claim 6, wherein the seal includes a slit that does not extend through the seal.

10. The ink refill container according to claim 6, the seal is configured to be torn by an ink inlet needle of the ink tank.
